(19) United States
(12) Patent Application Publication
(10) Pub. No.: US 2009/0213441 A1
(43) Pub. Date: Aug. 27, 2009

(54) LIGHT SOURCE DEVICE AND ORIGINAL DOCUMENT READING DEVICE

(75) Inventors: Loi Yew Kien, Singapore (SG); Ang Hwee San, Singapore (SG); Joanne Goh Li Chen, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/390,330

(22) Filed: Feb. 20, 2009

(30) Foreign Application Priority Data
Feb. 22, 2008 (JP) 2008-041888

(51) Int. Cl. H04N 1/04; F21V 33/00

(52) U.S. Cl. 358/474; 362/154

(57) ABSTRACT

Provided is a light source device including: a casing including an irradiation opening which supplies irradiation light to an irradiated object and an outlet which outputs the light reflected from the irradiated object to the outside thereof; a pair of reflection plates of which at least sides facing each other with the outlet interposed therebetween are arranged in the casing; and a light-emitting unit including point light-emitting sources arranged in the vicinity of at least one of the pair of reflection plates in the casing.

The entire disclosure of Japanese Patent Application No. 2008-041888, filed Feb. 22, 2008 is expressly incorporated by reference herein.

### BACKGROUND

1. Technical Field

The present invention relates to a light source device having point light-emitting sources as light sources and an original document reading device including the light source device.

2. Related Art

A light source device used in an original document reading device, for example, a scanner, needs to emit light such that a light amount distribution of an image sensor is uniform over the reading width of an original document. Recently, as a light-emitting diode comes into wide use, a light source using a light-emitting diode has been put into practical use. For example, a technique of using light-emitting diodes as light sources even in an original document reading device, that is, a scanner, is suggested (e.g., see U.S. Pat. No. 5,767,979).

However, since the light-emitting diodes are point light-emitting sources, it is difficult to irradiate irradiation light to an irradiated object in a uniform light amount distribution. In particular, if an arrangement interval between light-emitting diodes is large, non-uniformity of the light amount distribution is significantly increased. In contrast, if the arrangement interval between the light-emitting diodes is decreased, a larger number of light-emitting diodes are required and thus cost is increased.

In addition, even in the same arrangement interval between the light-emitting diodes, the non-uniformity of the light amount distribution is problematic in an irradiated object having a lustrous surface.

### SUMMARY

An advantage of some aspects of the invention is that it improves uniformity of a light amount distribution of a light source device including point light-emitting sources.

In order to solve at least a portion of the problems, the invention employs the following aspects.

According to a first aspect of the invention, there is provided a light source device including: a casing including an irradiation opening which supplies irradiation light to an irradiated object and an outlet which outputs the light reflected from the irradiated object to the outside thereof; a pair of reflection plates of which at least sides facing each other with the outlet interposed therebetween are arranged in the casing; and a light-emitting unit including point light-emitting sources arranged in the vicinity of at least one of the pair of reflection plates in the casing.

According to the light source device of the first aspect, since the pair of reflection plates of which at least sides facing each other with the outlet interposed therebetween are arranged in parallel, optical path lengths from the point light-emitting sources to the irradiation opening become equal and the uniformity of a light amount distribution can be improved.

In the light source device of the first aspect, the light-emitting unit may include a plurality of point light-emitting sources arranged along at least one of the pair of reflection plates. In this case, even in a larger light source device or a light source device for providing a larger amount of light, the uniformity of the light amount distribution can be improved.

In the light source device of the first aspect, the light-emitting unit may be arranged along a connection portion between the reflection plates and the casing. In this case, the optical path lengths of lights emitted from the light-emitting unit can become equal.

In the light source device of the first aspect, the light-emitting unit may be arranged on the reflection plates. In this case, the light-emitting unit can be easily mounted.

In the light source device of the first aspect, the light-emitting unit may include a first light-emitting unit and a second light-emitting unit which are respectively arranged on the pair of reflection plates. In this case, it is possible to obtain a larger amount of light.

In the light source device of the first aspect, the plurality of point light-emitting sources included in the first light-emitting unit and the plurality of point light-emitting sources included in the second light-emitting unit may be mutually arranged in a zigzag shape. In this case, since it is possible to suppress and prevent light amount spots due to overlapping of the point light-emitting sources and improve the uniformity of the light amount distribution even when the plurality of light-emitting units is included.

In the light source device of the first aspect, the first and second light-emitting units may be arranged along the connection portion between the reflection plates and the casing. In this case, the optical path lengths of lights emitted from the light-emitting unit can become equal.

In the light source device of the first aspect, the first and second light-emitting units may be respectively arranged on the reflection plates. In this case, the light-emitting unit can be easily mounted.

In the light source device of the first aspect, the pair of reflection plates is arranged such that the opposing surfaces thereof become parallel. In this case, the optical paths between the reflection plates can become equal.

According to a second aspect of the invention, there is provided an original document reading device including: the light source device according to the first aspect; and an original document reading unit reading an original document. In this case, since the light amount distribution is uniform, it is possible to suppress and prevent reading spots due to a non-uniform light amount distribution.

### BRIEF DESCRIPTION OF THE DRAWINGS

The invention will be described with reference to the accompanying drawings, wherein like numbers reference like elements.

FIG. 1 is a perspective view showing the schematic configuration of a light source device according to an embodiment of the invention.

FIG. 2 is a plan view of the light source device of the present embodiment.

FIG. 3 is a cross-sectional view showing an optical path length of the light source device according to the present embodiment taken along line III-III of FIG. 2.

FIG. 4 is a cross-sectional view showing an optical path of a directly reflected light of the light source device according to the present embodiment taken along line IV-IV of FIG. 2.

FIG. 5 is a view showing the schematic configuration of an original document reading device according to an embodiment of the invention.

FIG. 6 is a cross-sectional view showing an internal configuration example of a light source device when a front surface light emission type light-emitting diode is used as a light-emitting source according to a first other embodiment of the invention.

FIG. 7 is a cross-sectional view showing an internal configuration example of a light source device when a front surface light emission type light-emitting diode is used as a light-emitting source according to a second other embodiment of the invention.

FIG. 8 is a perspective view showing the schematic configuration of a light source device according to a third other embodiment of the invention.

FIG. 9 is a cross-sectional view showing the arrangement configuration of reflection plates of a light source device according to a fourth other embodiment of the invention.

FIG. 10 is a cross-sectional view showing the arrangement configuration of reflection plates of a light source device according to a fifth other embodiment of the invention.

### DESCRIPTION OF EXEMPLARY EMBODIMENTS

Hereinafter, a light source device and an original document reading device according to the embodiments of the invention will be described with reference to the accompanying drawings.

### Configuration of Light Source:

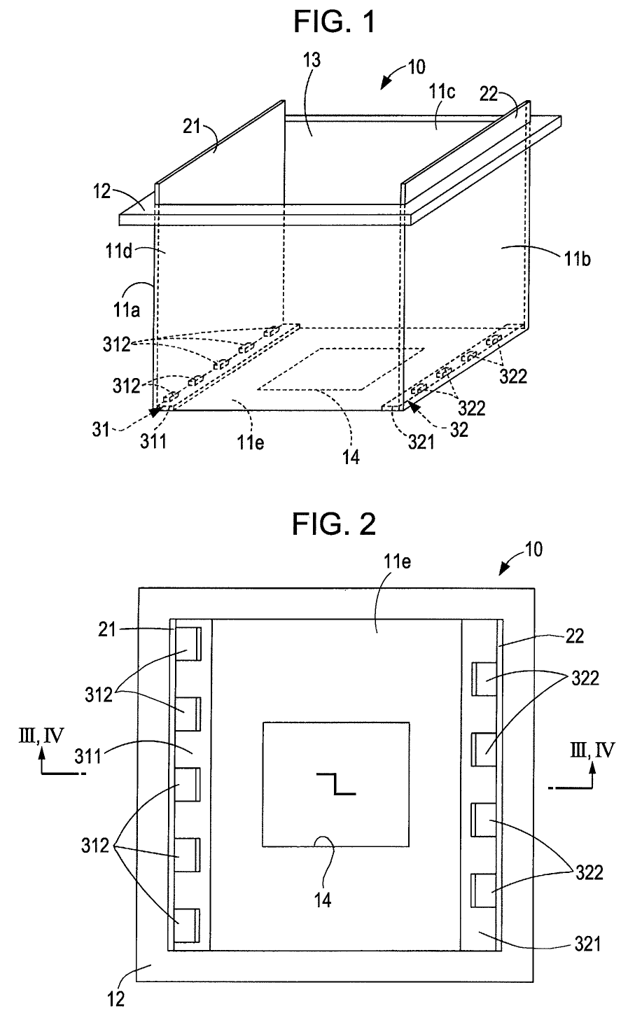

FIG. 1 is a perspective view showing the schematic configuration of a light source device according to an embodiment of the invention. FIG. 2 is a plan view of the light source device of the present embodiment.

The light source device 10 according to the present embodiment includes a casing 11, a pair of reflection plates 21 and 22, light sources 31 and 32. The casing 11 includes side surface members 11a to 11d and a bottom member 11e and has a box shape.

The casing 11 may have a rectangular parallelepiped shape as shown in FIG. 1 or a cubic shape. In addition, if the pair of reflection plates 21 and 22 may be arranged to face each other in parallel, the reflection plates may have a polyhedral column shape such as a pentagonal column shape or a hexagonal column shape or a spherical shape. If the reflection plates have an even-number polyhedral column shape or a spherical shape, the pair of reflection plates 21 and 22 may be easily arranged to face each other in parallel. An opening formed by the side surface members 11a to 11d functions as an irradiation opening 13 for supplying irradiation light to an irradiated object. In the bottom member 11e, an outlet 14 for outputting reflection light from the irradiated object to the outside thereof is formed. The shape of the outlet 14 is not limited to a rectangular shape and may be a circular shape. A flange 12 is formed in the front surface of the casing 11. In addition, in order to facilitate the description, the thicknesses of the side surface members 11a to 11d and the bottom member 11 are not shown in the figure, but these members 11a to 11e actually have respective thicknesses.

The reflection plates 21 and 22 are arranged in the casing body 11 such that opposing sides thereof are arranged in parallel with at least the outlet 14 interposed therebetween. In more detail, for example, the reflection plates 21 and 22 are adhered to the side surface members 11a and 11b, respectively. Although, in the example of FIG. 1, the reflection plates 21 and 22 are arranged such that the sides thereof are arranged in parallel, the reflection plates may be arranged such that the optical path lengths of the lights reflected from the reflection plates 21 and 22 are equal over a direction parallel to the bottom member 11e. That is, the reflection plates 21 and 22 are arranged such that the whole optical path lengths from the reflection plates to the irradiation opening 13 are equal. By this arrangement, the amount of irradiation light irradiated from the irradiation opening 13 to the irradiated object becomes uniform. The reflection plates 21 and 22 may have, for example, a mirror surface, on which aluminum is deposited, on the surface thereof or a white surface with high reflectivity.

The light sources 31 and 32 have substrates 311 and 321 and a plurality of light-emitting diodes 312 and 322 arranged on the substrates 311 and 321 as point light-emitting sources, respectively. The substrates 311 and 321 are arranged along the bottoms of the reflection plates 21 and 22 which are in contact with the bottom member 11e. In more detail, for example, the substrates 311 and 321 are adhered to the bottom member 11e to be parallel to the reflection plates 21 and 22. The light-emitting diodes 312 and 322 used in the present embodiment are a side surface light emission type white (visible light) light-emitting diodes. The light-emitting diode 312 arranged on the substrate 311 and the light-emitting diode 322 arranged on the substrate 321 are arranged to be deviated from each other in a zigzag shape as shown in FIG. 2 such that the arrangement position of the light-emitting diode 312 on the substrate 311 and the arrangement position of the light-emitting diode 322 on the substrate 321 do not overlap with each other. As described above, in the present embodiment, the reflection plates 21 and 22 are arranged such that the optical path lengths of the irradiation lights from the light-emitting diodes 312 and 322 to the irradiation opening 13 become equal. Accordingly, at least main lights of the lights emitted from the light-emitting diodes 312 and 322 do not overlap each other such that the uniformity of the light amount distribution to the irradiated object is improved.

### Optical Path of Light Source Device:

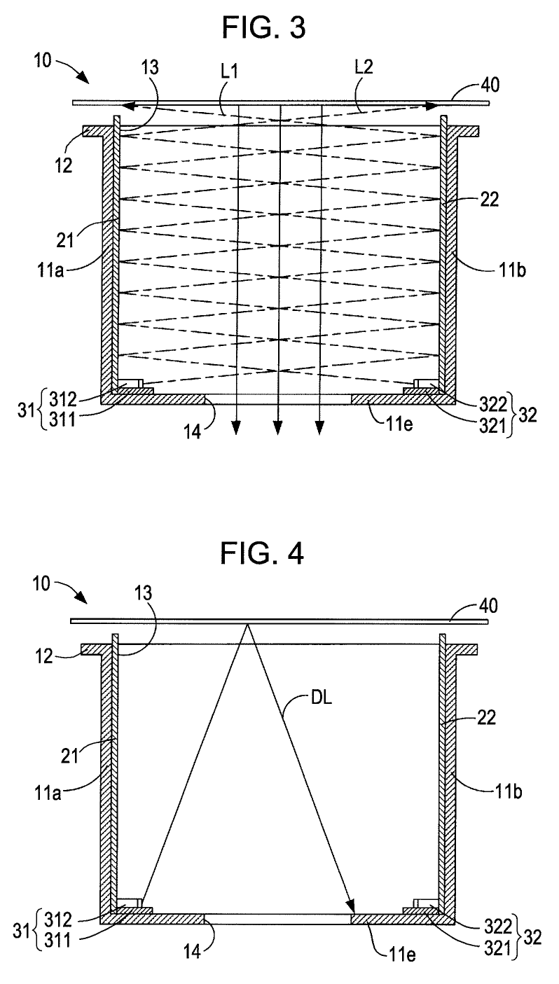

The optical path characteristic of the light source device 10 according to the present embodiment will be described with reference to FIGS. 3 and 4. FIG. 3 is a cross-sectional view showing an optical path length of the light source device according to the present embodiment taken along line III-III of FIG. 2. FIG. 4 is a cross-sectional view showing an optical path of a direct reflected light of the light source device according to the present embodiment taken along line IV-IV of FIG. 2. In addition, in FIGS. 3 and 4, a reference numeral 40 denotes an irradiated object. As described above, in the present embodiment, the reflection plates 21 and 22 are arranged such that the optical path lengths of the lights emitted from the light sources 31 and 32 to the irradiation opening 13 becomes equal. That is, as shown in FIG. 3, when the lights emitted from the light-emitting diodes 312 and 322 of the light sources 31 and 32 are reflected from the reflection plates 21 and 22 plural times to reach the irradiation opening 13, all the optical path lengths L1 and L2 are equal. As a result, the irradiation light amount of the irradiated object 40 is equal over the irradiation area of the irradiated object 40 such that the uniformity of the light amount distribution can be achieved.

In the present embodiment, as shown in FIG. 4, among the lights (main light rays) emitted from the light-emitting diodes 312 and 322, the arrangement positions of the light sources 31 and 32 are decided such that a directly reflected light DL which directly reaches and reflects from the irradiated object 40 is not output from the outlet 14 to the outside thereof. Alternatively, in the state in which the arrangement positions of the light sources 31 and 32 are fixed, the size of the outlet 14 may be decided such that the directly reflected light DL is not output from the outlet 14. Generally, since the light sources 31 and 32 have irradiation angles in horizontal and vertical directions within a predetermined range (reference range), the size of the outlet 14 may be decided according to the irradiation angles of the main light rays in the vertical direction such that the directly reflected light DL is not output from the outlet 14. As a result, it is possible to reduce or prevent light amount spots due to the directly reflected light DL with high intensity (luminance), compared with an indirectly reflected light reflected from the reflection plates 21 and 22.

In addition, the arrangement positions of the light sources 31 and 32 may be decided such that the directly reflected light DL output from the outlet 14 does not reach an image sensor (image pickup unit). Alternatively, in a state in which the arrangement positions of the light sources 31 and 32 are fixed, the size of the outlet 14 may be decided such that the directly reflected light DL output from the outlet 14 does not reach the image sensor. That is, the directly reflected light DL output from the outlet 14 is not parallel to (has an angle of crossing) an optical axis of an optical system including image sensor so as not to reach an incident surface of the image sensor. In this case, it is possible to increase a free degree of the arrangement positions of the light sources 31 and 32 compared with the case where the directly reflected light DL is not output from the outlet 14, and to reduce or prevent light amount spots due to the directly reflected light DL with high intensity (luminance) compared with an indirectly reflected light reflected from the reflection plates 21 and 22.

### Application Example of Light Source Device:

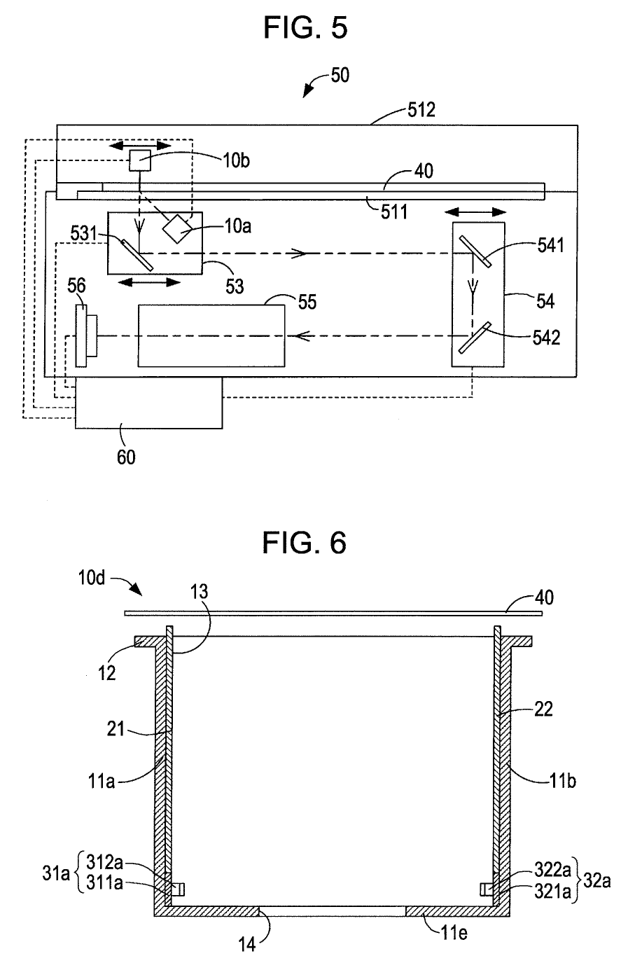

FIG. 5 is a view showing the schematic configuration of an original document reading device according to an embodiment of the invention. The original document reading device 50 according to the present embodiment includes a reflection light source device 10a, an original document placing glass 511, an original document cover 512, a scanning unit 53, a movable mirror unit 54, an optical lens unit 55, an image pickup unit 56, a transmission light source device 10b, and a control device 60.

The reflection light source 10a is a light source device used for a reflection original document such as a document or an image. The transmission light source device 10b is a light source device used for a transmission original document such as a negative film or a positive film. The reflection light source device 10a is arranged in the scanning unit 53 and the transmission light source device 10b is arranged in the original document cover 512. The transmission light source device 10b may move in a direction denoted by an arrow (a sub-scanning direction) in the original document cover 512 in interlock with the scanning unit 53 by a driving mechanism (not shown). In addition, in the transmission light source device 10b, a visible light source or an infrared light source may be included.

In the scanning unit 53, a reflection mirror 531 is included in addition to the reflection light source device 10a. The scanning unit 53 moves in the direction denoted by the arrow by the driving mechanism (not shown), scans an original document 40 as an irradiated object placed on the original document placing glass 521, and performs a reading process of the original document 40.

The movable mirror unit 54 has reflection mirrors 541 and 542. The movable mirror unit 54 also moves in the direction denoted by the arrow by the driving mechanism (not shown) in interlock with the scanning unit 53, when the original document is read. As the driving mechanism, for example, the known driving mechanism using a timing belt may be used.

The optical lens unit 55 has one or a plurality of lenses and is a lens unit of a reduced optical system, which focuses light received from the movable mirror unit 54 onto the image pickup unit 56.

The image pickup unit 56 is a semiconductor device for outputting a voltage value corresponding to a light reception amount and generally includes a light-receiving element for converting incident light into electric charges and an element for transmitting the electric charges generated by the light-receiving element. As the image pickup unit 56, for example, a charge coupled device (CCD) sensor using a CCD or a complementary metal oxide semiconductor (CMOS) sensor using a CMOS may be used in a transmission circuit. In the present embodiment, a plurality of light-receiving elements is arranged in the image pickup unit 56 in a horizontal direction and color filters of R, G and B are mounted in each of the light-receiving elements.

The control device 60 includes a central processing unit (CPU) (not shown), a memory, an input/output interface and so on. The control device 60 controls ON/OFF of the reflection light source device 10a, the visible light source of the transmission light source device 10b, ON/OFF of the infrared light source, and the operations of the scanning unit 53 and the movable mirror unit 54. The control device 60 acquires image data of the original document 40 read by the image pickup unit 56.

As described above, according to the light source device 10 according to the present embodiment, since the reflection plates 21 and 22 are arranged such that the optical path lengths from the light sources 31 and 32 to the irradiation opening 13 become equal, the light amount distribution of the light irradiated to the irradiated object 40 becomes uniform over the irradiated area of the irradiated object 40. As a result, if the original document reading device 50 includes the light source device 10, it is possible to reduce or prevent reading spots due to a variation in luminance when the light reflected from the irradiated object 40 is read and is converted into image data.

In addition, according to the light source device 10 of the present embodiment, since the light-emitting diodes 312 and 322 are arranged in the zigzag shape in the light sources 31 and 32, it is possible to suppress or prevent light amount spots due to overlapping of the emitted lights and, more particularly, overlapping of the main light rays.

According to the light source device 10 of the present embodiment, since the directly reflected light directly irradiated and reflected from the light-emitting diodes 312 and 322 of the light sources 31 and 32 to the irradiated object 40 are not output from the outlet 14 of the light source device 10 to the outside thereof, it is possible to suppress or prevent reading spots due to the directly reflected light. That is, since it is possible to reduce or prevent a variation in luminance due to the directly reflected light included in the reflected light from the irradiated object 40, it is possible to suppress or prevent reading spots due to the variation in luminance spots by image data of the irradiated object 40 in the original document reading device 50 including the light source device 10.

As described above, according to the light source device 10 of the present embodiment, it is possible to make the irradiation distribution uniform without increasing the number of light-emitting sources. In addition, it is possible to suppress or prevent a variation in reflected light luminance due to a variation in irradiation distribution, even in an irradiated object having a lustrous surface.

### Other Embodiments

### (1) First and Second Other Embodiments

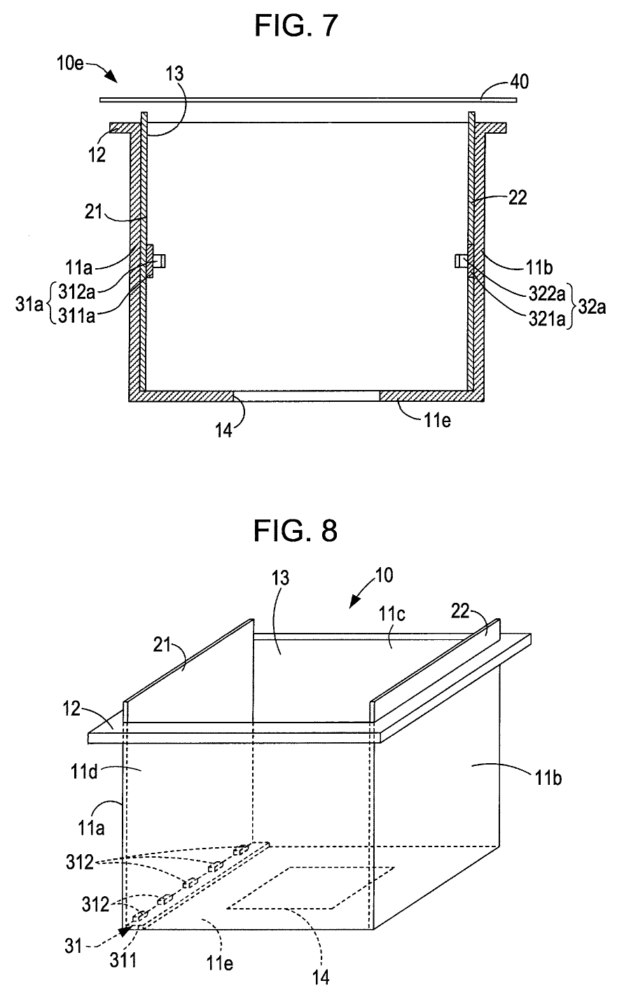

Although the side surface light emission type light-emitting diodes 312 and 322 are used in the above embodiment, front surface light emission type light emitting diodes 312a and 322a may be used. FIG. 6 is a cross-sectional view showing an internal configuration example of a light source device 10d when a front surface light emission type light-emitting diode is used as a light-emitting source according to a first other embodiment of the invention. FIG. 7 is a cross-sectional view showing an internal configuration example of a light source device 10e when a front surface light emission type light-emitting diode is used as a light-emitting source according to a second other embodiment of the invention.

In the light source device 10d according to the first embodiment, light sources 31a and 32a including front surface light emission type light-emitting diodes 312a and 322a are arranged so as to be in contact with side surface members 11a and 11b and a bottom member 11e. In detail, the rear surfaces of substrates 311a and 321a of the light sources 31a and 32a (the rear surfaces of the surfaces on which the light-emitting diodes 312a and 322a are mounted) are adhered to the side surface members 11a and 11b. Reflection plates 21 and 22 are adhered to the side surface members 11a and 11b from the substrates 311a and 321a of the light sources 31a and 32a toward an irradiation opening 13. Even in this configuration, the same effects as the above embodiment can be obtained.

In the light source device 10e according to the second other embodiment shown in the left side of FIG. 7, light sources 31a and 32a including the front surface light emission type light-emitting diodes 312a and 322a are arranged in the central portions of reflection plates 21 and 22 adhered to side surface members 11a and 11b (the central portions from a bottom member 11e toward an irradiation opening 13). By this configuration, the light sources 31a and 32a may be easily arranged in parallel to the reflection plates 21 and 22. In the light source device 10e according to the second other embodiment shown in the left side of FIG. 7, the light sources 31a and 32a including the front surface light emission type light-emitting diodes 312a and 322a are arranged in the central portions of the side surface members 11a and 11b (the central portions from the bottom member 11e toward the irradiation opening 13). The reflection plates 21 and 22 are adhered to the side surface members 11a and 11b with the light sources 31a and 32a interposed therebetween, respectively. Even in this configuration, the same effects as the above embodiment can be obtained.

### (2) Third Other Embodiment

Although the two light sources 31 and 32 are included in the above embodiment, as shown in FIG. 8, only one light source 31 may be included. FIG. 8 is a perspective view showing the schematic configuration of a light source device according to a third other embodiment of the invention. The number of light sources may be modified according to the size of the light source device 10 and the required irradiated light amount. Even in this configuration, as long as the optical path length from the light-emitting diode 312 of the light source 31 to the irradiated object is equal, the light amount distribution of the irradiated object is uniform. Thus, the same effects as the above embodiment can be obtained.

### (3) Fourth and Fifth Other Embodiments

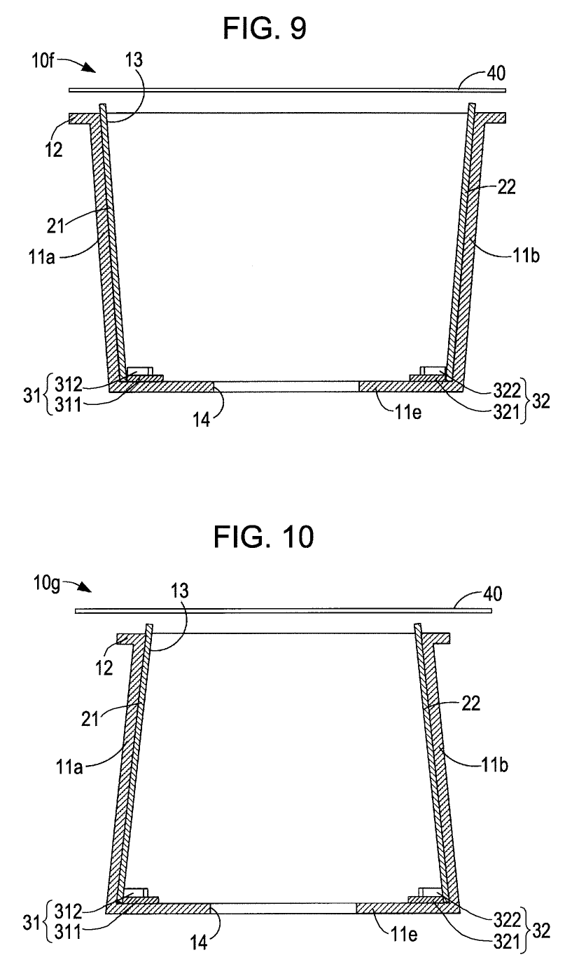

Although the pair of reflection plates 21 and 22 is arranged in parallel over the whole surfaces in the above embodiment, as shown in FIGS. 9 and 10, if the sides which face each other with at least the outlet 14 interposed therebetween are parallel, the same effects as the above embodiment can be obtained. FIG. 9 is a cross-sectional view showing the arrangement configuration of reflection plates of a light source device according to a fourth other embodiment of the invention. FIG. 10 is a cross-sectional view showing the arrangement configuration of reflection plates of a light source device according to a fifth other embodiment of the invention. Even in the light source devices 10f and 10g of the fourth and fifth other embodiments, since the optical path lengths from light-emitting diodes 312 and 322 of the light sources 31 and 32 to an irradiated opening 13 are equal, the light amount distribution of the light irradiated to the irradiated object 40 is uniform. That is, at least the sides of the reflection plates 21 and 22 are parallel to a direction perpendicular to the irradiation direction of the irradiated light.

(4) Although the light-emitting diodes 312 and 322 of the light sources 31 and 32 are arranged in the zigzag shape in the above embodiment, for example, if the irradiated object 40 having low reflectivity is used, the light-emitting diodes 312 and 322 may be arranged such that the main light rays overlap. That is, it is determined whether or not the light-emitting diodes 312 and 322 are arranged in the zigzag shape, according to the level of the uniformity of the light amount distribution of the light source device 10.

(5) Although an example of using two light sources is described in the above embodiment, three light sources or four light sources may be included. In this case, the reflection plates which may be included with respect to the third and fourth light sources are arranged such that the optical path lengths from the third and fourth light sources to the irradiation opening 13 are equal, similar to the reflection plates 21 and 22. In addition, although the light sources 31 and 32 including the plurality of point light-emitting sources (light-emitting diodes) are used in the above embodiment, a single light-emitting diode may be included in each of the light sources 31 and 32 according to the size of the light source device 10.

(6) Although the two light sources 31 and 32 are arranged in parallel to the pair of reflection plates 21 and 22 in the above embodiment, if the optical path lengths from the light sources 31 and 32 to the irradiation opening 13 are equal, the light sources 31 and 32 may not be arranged in parallel to the reflection plates 21 and 22. That is, the optical path lengths from the light sources 31 and 32 to the irradiation opening 13 may become equal by the reflection plates 21 and 22. In addition, the reflection plates 21 and 22 may be arranged such that the optical path lengths from the light sources 31 and 32 to the irradiation opening 13 may become equal, and the reflection plates may not be arranged in parallel to the light sources 31 and 32 according to the shapes of the light sources 31 and 32.

(7) Although the irradiation opening 13 is an opening formed by the side surface members 11a to 11d, a front surface member is separately included and an irradiation opening having any shape may be formed. In this case, it is possible to easily realize an irradiation range in conformity with its object.

(8) Although the white light-emitting diodes are used as the point light-emitting sources 312 and 322 in the above embodiment, for example, light-emitting diodes of red, green and blue may be used as the light sources. In addition, although the light-emitting diodes are used as the point light-emitting sources, other point light-emitting sources, for example, a small bulb using a general filament may be used.

(9) Although the original document 40 is read by moving the scanning unit 53 in the original document reading device 50 of the present embodiment, the original document 40 may move above the fixed scanning unit. That is, the original document and the scanning unit (reading unit) may relatively move. In addition, the original document indicates an object to be read in addition to a document and an image.

(10) Although an example of applying the light source device 10 to the original document reading device 50 is described in the above embodiment, various devices which can read the original document by using the light source device 10, such as a facsimile, a copier, a multifunction machine, and a hand scanner, may be used.

Although the embodiments and the modified examples of the invention are described above, the embodiments of the invention are described for facilitating the understanding of the invention and are not limited to the invention. The invention may be modified or improved without departing the scope and claims of the invention and may include the equivalents thereof.

What is claimed is:

1. A light source device comprising:
a casing including an irradiation opening which supplies irradiation light to an irradiated object and an outlet which outputs the light reflected from the irradiated object to the outside thereof;
a pair of reflection plates of which at least sides facing each other with the outlet interposed therebetween are arranged in the casing; and
a light-emitting unit including point light-emitting sources arranged in the vicinity of at least one of the pair of reflection plates in the casing.

2. The light source device according to claim 1, wherein the light-emitting unit includes a plurality of point light-emitting sources arranged along at least one of the pair of reflection plates.

3. The light source device according to claim 1, wherein the light-emitting unit is arranged along a connection portion between the reflection plates and the casing.

4. The light source device according to claim 1, wherein the light-emitting unit is arranged on the reflection plates.

5. The light source device according to claim 1, wherein the light-emitting unit includes a first light-emitting unit and a second light-emitting unit which are respectively arranged on the pair of reflection plates.

6. The light source device according to claim 5, wherein the plurality of point light-emitting sources included in the first light-emitting unit and the plurality of point light-emitting sources included in the second light-emitting unit are mutually arranged in a zigzag shape.

7. The light source device according to claim 5, wherein the first and second light-emitting units are arranged along the connection portion between the reflection plates and the casing.

8. The light source device according to claim 5, wherein the first and second light-emitting units are respectively arranged on the reflection plates.

9. The light source device according to claim 1, wherein the pair of reflection plates are arranged such that the opposing surfaces thereof become parallel.

10. An original document reading device comprising:
the light source device according to claim 1; and
an original document reading unit reading an original document.
